(19) United States
(12) Patent Application Publication
(10) Pub. No.: US 2003/0169977 A1
(43) Pub. Date: Sep. 11, 2003

(54) Low stress mounting device for photonic integrated circuit chips

(76) Inventors: Zhene Xu, Fremont, CA (US); Alexander Chang, San Jose, CA (US)

Correspondence Address: David T. Yang, Morrison & Foerster LLP, Suite 3500, 555 West Fifth Street, Los Angeles, CA, 90013-1024, US

(21) Appl. No.: 10/094,114

(22) Filed: Mar. 8, 2002

(51) Int. Cl. G02B 6/42; G02B 6/30; G02B 6/26; G02B 6/12

(52) U.S. Cl. 385/88; 385/49; 385/52; 385/14

(57) ABSTRACT

The present invention is directed to an apparatus and method for packaging and assembling of optical communication components, such as optoelectronic integrated circuits and photonic integrated circuits. Specifically, the present invention is directed to an apparatus and method for mounting an optical communication component onto a mounting plate whereby the optical communication component is support by multiple support structures, the support structures including support posts or a series of geometrically configured holes, such that the support structures can absorb significant stress that may be created by the different thermal expansion properties between the mounting plate and the mounted optical communication component.

### BACKGROUND

1. Field of Invention

The present invention relates generally to the packaging and assembling of electrical and optical devices, such as optoelectronic integrated circuits (OEIC) and photonic integrated circuits (PIC).

2. Description of Related Arts

Fiber-optic communication systems have been used extensively in many technical areas, such as, telecommunication transmission, data transmission, CATV and video transmission and distribution. More recently, dense wavelength division multiplexed (DWDM) systems have become more important as a result of their ability to utilize the significant bandwidth of single mode fiber optic cables.

Networks based on DWDM technology may include a variety of optical devices and components, such as lasers, photodiodes, optical multiplexer/demultiplexer, modulators, optical switch matrixes, optical amplifiers, optical filters, optical attenuators, and optical add/drop modulators. However, large numbers of individual devices can make the network or system unstable and costly to build and/or maintain. High reliability and low cost is the inevitable demand of the future networks, and photonic integrating and optoelectronic integrating are ways to achieve such goals. The difficulty of integrating photonic and optoelectronic devices stems from the fact that these devices are generally made of different materials, and can thus cause thermal expansion property mismatch in a hybrid integrated package where different materials are joined together.

The joining of dissimilar materials in these situations often cause challenges in fabrication, storage, and functionality due to shear stress found at the interface between such materials. Specifically, when a device is composed of two or more layers of material having different thermal expansion coefficient (TEC), a bimetal effect occurs between the adjoining surfaces of the metal layers. Bimetal effect occurring between an optical/electronic chip and a mounting plate can result in bowing of the chip and the plate, and can also cause severe stress at the interface between the chip and the plate as the environmental temperature varies.

For example, many photonic chips are made of silica as the waveguide layer and silicon as a support substrate. The bimetal effect between silica and silicon not only cause bowing, but also causes stress at the interface between the two materials as the environmental temperature varies. In this instance, if the surrounding temperature goes up, then the silicon will expand more than the silica. The result is that the silica/silicon pair becomes concave on the silica side and convex on the silicon side, and the interface between the two materials experiences shear stress.

To illustrate the bimetal effect, FIG. 1A is a cross-sectional schematic view illustrating a conventional mounting structure, including a silica portion 14 coated on to a silicon portion 19. At room temperature, both silica portion 14 and silicon portion 19 remain flat relative to each other.

FIG. 1B illustrates the structure of FIG. 1A at higher temperature. As the surrounding temperature increases, silicon portion 19 extends more than silica portion 14 due to the difference in thermal expansion properties. As a result, the two-layer structure becomes concave on the silica side and convex on the silicon side. This bowing is a result of the above-mentioned bimetal effect.

Because optical chips are relatively larger than the electronic chips, stress caused from thermal mismatching is more of a significant problem in OEIC and PIC device packaging than that in the electronic device packaging. In addition, optical functionality, such as polarization dependence loss, can be adversely affected by excessive stress caused from the above-described bimetal effect.

Conventionally, to minimize thermal expansion property mismatch, the same material for both the optical chips and the mounting plate that package those chips (See, e.g., U.S. Pat. No. 4,750,800) are used. Alternatively, if different material must be used, a manufacturer may add temperature control measures to minimize packaging stress that may result from the different thermal expansion properties of the optical chip and the mounting plate. For both methods, the result is the added cost, additional engineering effort, and bulkiness of the final product.

Another method of minimizing the bimetal effect is via the use of thick adhesives (such as the one disclosed in U.S. Pat. No. 6,106,161) for the bonding of optical chip and mounting substrate. Using this conventional method, stress caused from the thermal mismatch between the optical chip and mounting plate can sometimes be absorbed by such a thicker adhesive as such thick adhesive can exhibit expanding/contracting characteristics. However, this mounting method is not suitable for situations where passive alignment is used to align an optical waveguide and fiber, whereby the use of relatively thick adhesive layer can sacrifice the accuracy and precision of alignment between the optical device to a waveguide. Furthermore, over time, the repeated expansion and contraction of the thick adhesive may cause the adhesive to deteriorate.

### SUMMARY OF THE INVENTION

It is an object of this invention to provide a low-stress packaging mounting plate for supporting circuit devices that are made of different material from the mounting plate.

It is another object of this invention to provide a low-stress mounting plate for passive alignment of the mounted circuit devices so that accurate alignment with maximum coupling efficiency to an optical transmission medium can be achieved.

It is another object of this invention to provide a low stress mounting plate that compensates for and absorbs stress deflection caused by thermal expansion differences between a mounting plate and a mounted circuit chip so that the warping and deflection of the mounted chips caused by the different thermal expansion properties can be substantially avoided.

It is still another object of this invention is to provide a mounting plate for the low stress packaging of devices that are made of anisotropic thermo-expansion material, such as LiNbO₃, LiTaO₃, and equivalents.

In accordance with the preferred embodiment of the present invention, a low stress mounting method and structure plate for packaging electrical and optical devices is provided for mounting optoelectronic integrated circuits (OEIC), photonic integrated circuits (PIC), or a combination of optical and electronic chips (hereafter using OE chips to include the above-mentioned devices). The mounting plate is designed for supporting OE chips in aligned relationship with other spatially disposed electrical and optical components. Specifically, the mounting plate body portion includes a plurality of closely spaced support post or holes as support structures that are spatially disposed on the mounting surface of the mounting plate body portion. In the instance where the support structures are holes, the holes are closely spaced as to form a honeycomb-like array of holes, the shape of holes being any one of commonly known geometric configurations. The support structures are a plurality of spatially disposed holes, or a plurality of support posts, for providing OE chip support and absorbing the stress caused from any thermal expansion property mismatch between the two different materials.

While the support structures may include columns, post members, or holes, the geometric shape of the mounting surface of a support structures may be, for example, cylindrical, rectangular, square, hexagonal, triangular, taper members or any combinations thereof. By using the support structures to mount the OE chip, thermal stress in the interface, due to thermal material mismatch between the mounting plate and the OE chip, is re-distributed and released by the support structures. Specifically, thermal stress in the interface cause by thermal material mismatch between the mounting plate and the OE chip is mechanically absorbed by the support structures of the mounting plate so that substantially less warping or deflection is forced directly on the OE chips. As a result, the mounted OE device is not subjected to any significant stain or stress.

Another aspect of this invention relates to an optical passive alignment of OE chips to achieve maximum coupling efficiency of optical integrated circuits to an input of an optical transmission medium, such as an optical fiber or optical waveguide. Such components may be mounted on the low stress mounting plate of this invention to reliably ensure their stable alignment after their initial set alignment. Because thick adhesive is not needed to mount the component in the present invention, precise alignment may be better achieved. The optical system of this embodiment of the invention provides for coupling an input/output waveguide of optical device to optical transmission medium. The optical passive alignment system may also include grooves or its equivalent for the positioning of optical fiber, and also includes micro-stops or its equivalents for the positioning of OE chips.

Other objects and attainments together with a full understanding of the invention will become apparent and appreciated by referring to the following description taken in conjunction with the accompanying drawings.

### BRIEF DESCRIPTION OF THE DRAWINGS

FIG. 1A is a cross-sectional schematic view illustrating a conventional mounting structure;

FIG. 1B is a schematic diagram of a computer thermal deflection simulation of a conventional mounting plate configuration;

FIG. 2 is a perspective view of a low stress mounting structure with a mounted PIC device and optical fibers as mounted on the mounting plate in accordance with a preferred embodiment of the present invention;

FIG. 2A is a cross sectional view of the mounting structure shown in FIG. 2 taken along the line 3-3 in FIG. 2;

FIG. 2B is a perspective view of the low stress mounting plate of FIG. 2;

FIG. 2C is a schematic diagram of a computer thermal deflection simulation of the thermal stress results of the mounting plate configuration comprising the preferred embodiment;

FIG. 2D is the schematic pattern of the variations in support post size and spacing.

FIG. 3 is a perspective view of a low stress mounting structure in accordance with an alternative embodiment of the present invention;

FIG. 3A is a cross sectional view of the mounting structure shown in FIG. 3 taken along the line 4-4 in FIG. 3;

FIG. 3B is a perspective view of a low stress mounting plate with the array of holes as support structure in FIG. 3 in accordance with another alternative embodiment of the present invention;

FIG. 3C is a perspective view of a low stress mounting plate with an array of hexagonal holes as support structure in FIG. 3 in accordance with yet another alternative embodiment of the present invention;

FIG. 3D is a perspective view of a low stress mounting plate with an array of rectangular hole as support structure in FIG. 3 in accordance with yet another alternative embodiment of the present invention.

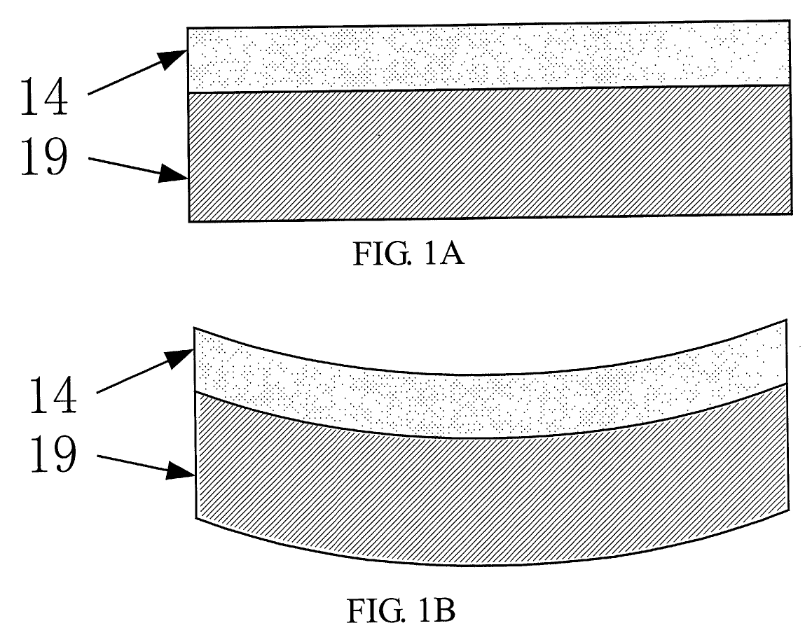

### DETAILED DESCRIPTION OF THE EMBODIMENTS

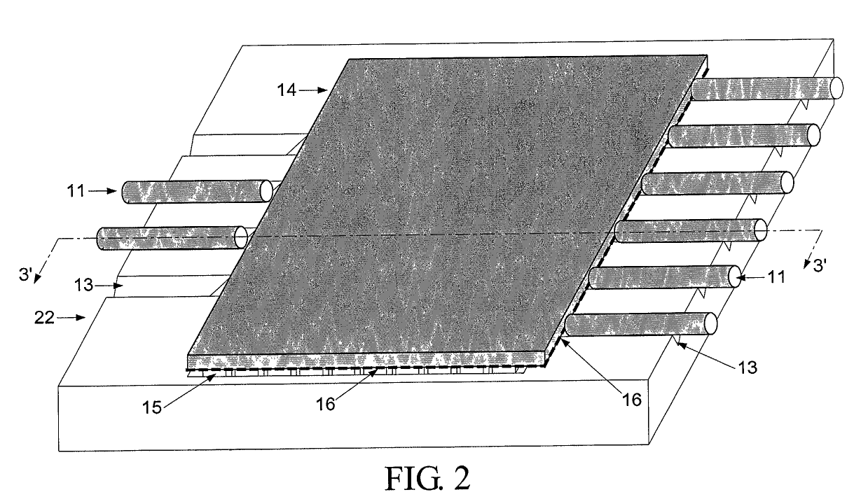

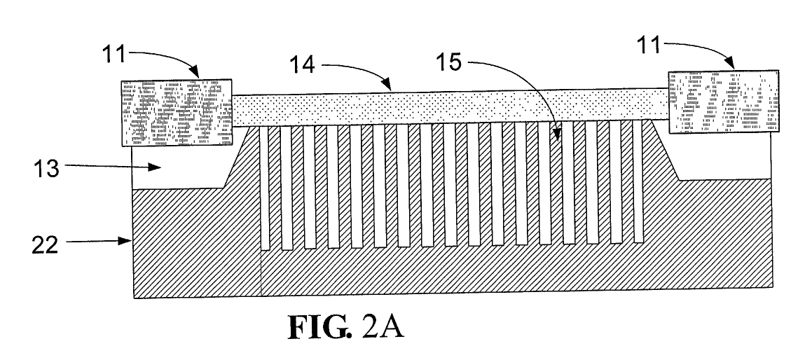

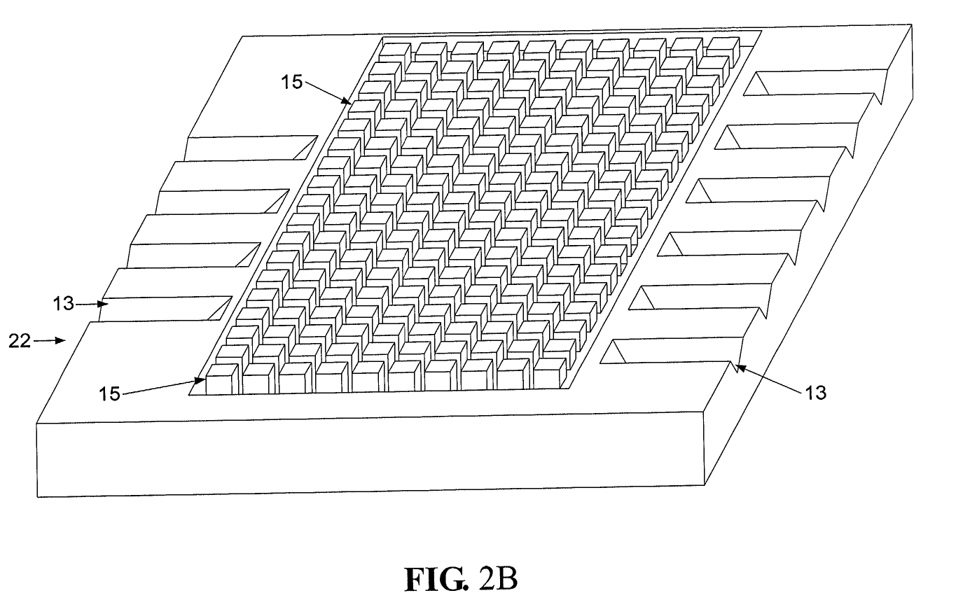

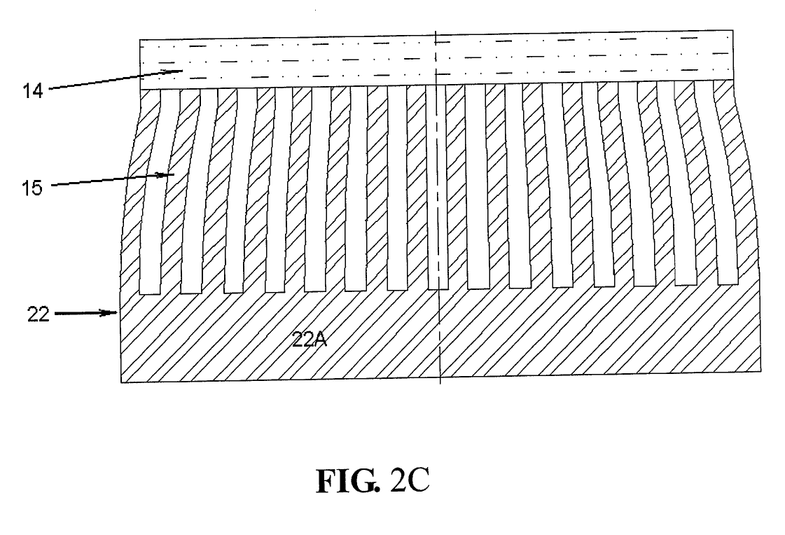

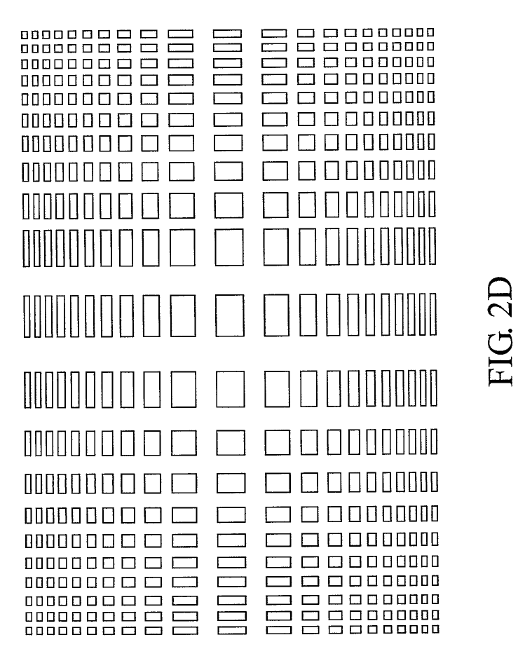

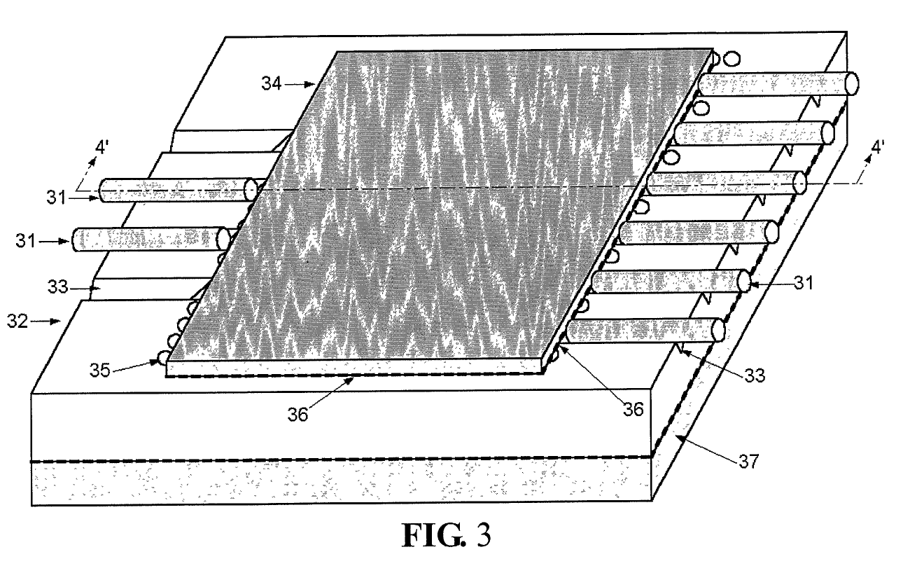

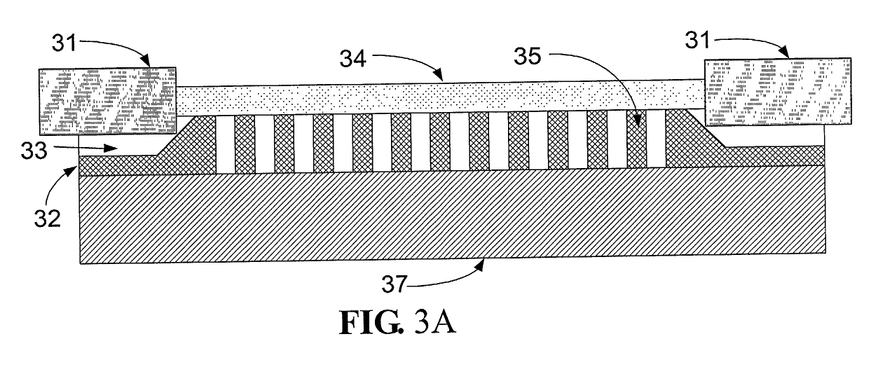

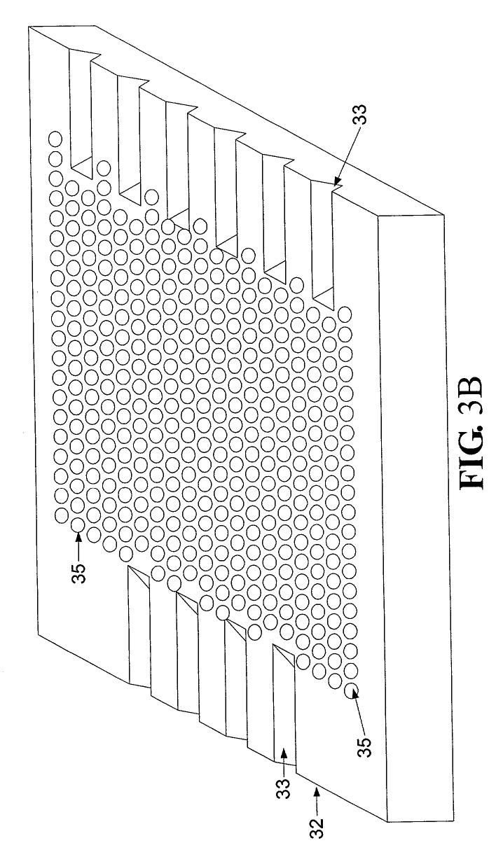

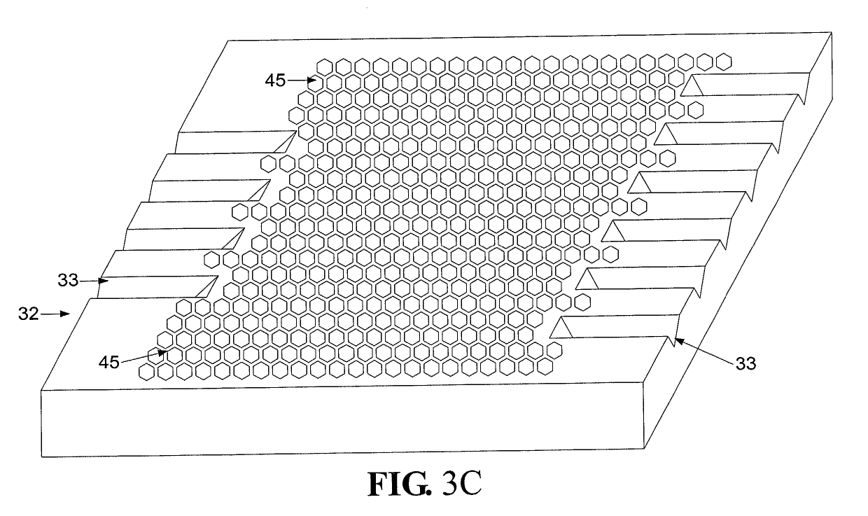

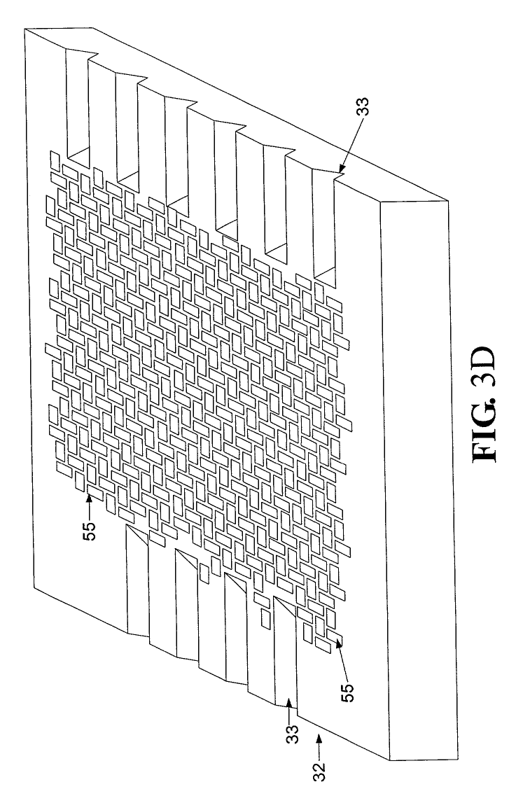

The embodiments of the present invention will now be discussed with reference to FIGS. 2-3D.

The preferred embodiment of a low stress mounting device is shown in FIG. 2, which comprises the mounting plate 22, optical fiber 11 and OE chip 14. The mounting plate 22 includes a body portion provided with a segmented support post and V-groove design, and may be comprised of silicon, glass, ceramic, polymer, or metal material to provide for low thermal resistance and good heat transfer characteristics. The chip 14, via support posts 15, is preferably mounted on the upper surface of mounting plate 22, which is conventionally accomplished, for example, by means of solder or adhesive.

FIG. 2A shows the cross sectional view of a mounting device in accordance with the preferred embodiment, which includes mounting plate 22, V-grooves 13 for receiving and supporting optical fibers 11, and support posts 15 located on the upper mounting surface of the mounting plate for receiving and supporting an OE chip. The illustration of the support post in FIG. 2B is just one of many different geometric shapes for support posts that can be used to support the OE chips and for decreasing the shear stress between the mounted OE chip and the mounting plate. The V-grooves 13 can secure the positioning and alignment of the optical fibers 11 to the mounting plate. The positioning of OE chip 14 can be realized by, for instance, positioning marks or stubs on the main body of mounting plate 22, which is not shown in this diagram.

The optical fibers 11 are preferably single mode fibers with a core diameter on the order of 5-11 microns and a cladding diameter of approximately 120-130 microns. The OE chip 14 thickness (t) is preferably between 500-1000 microns, with length and width selected accordingly for different applications. One or both ends of the optical waveguides of OE chip exposed by dicing are preferably polished at an angle between 6 and 12 degrees relative to a direction normal to the major surfaces of the mounting plate, to minimize reflection of optical signals at the ends of the optical waveguides. At the end or ends of the OE chip, the V-groove 13 and the optical waveguide ends are exposed and have laterally spaced relationship where the optical fibers are preferably spaced apart from each other at intervals of 250 microns. The support posts 15 may be in different geometric configurations, such as cylindrical, support post in rectangular, hexagonal format, cone and so on. It should be noted that the dimensions of the optical fiber and the thickness of the OE chip are discussed here merely for example purposes, and are not requirements for practicing the preferred embodiment of the present invention.

FIG. 2C illustrates the effects of a computer-simulated thermal stress deflection on mounting structure 22, wherein the computer simulates changes in environmental temperature that may cause material to expand or contract in accordance with their respective thermal expansion coefficients. In accordance with the preferred embodiment, if the OE chip is raised in temperature, the stress caused by the difference in thermal expansion between the mounting plate and the OE chip can be substantially absorbed by the support post structures 15, as illustrated by the distorted profile of these support posts illustrated in FIG. 2C. It can been seen from FIG. 2C that the thermal expansion stress is distributed to the support posts that are supporting the OE chip. Furthermore, it can be seen in FIG. 2C that the support posts located on the peripheral area may bear more stress than the support posts located more towards the center of the mount. In accordance with the preferred embodiment, because the stress caused by thermal expansion differentials are distributed to the support posts, there is no significant deflection at the surface of the OE chip 14 since the majority of the stress deflection is absorbed by support posts 15, leaving the lower bulk body portion 22A of mounting plate 22 and the OE chip 14 substantially free of any such stress. As a result, the interface between the OE chip 14 and the mounting plate 22 remains substantially stress free regardless of the varying temperature levels.

In accordance with an alternative embodiment, the arrangement of support post size and spacing can vary. Specifically, because the bowing or deflection of the OE chip caused by thermal stress is less significant at the center of mounted OE chip than at the periphery of the chip, the diameters of the support posts that support the center area of the OE chip can be larger than the diameters of the support posts supporting the periphery of the OE chip, thereby providing a larger contact area between the support posts located at the center of the OE chip and the OE chip itself and this providing a more substantial overall support to the mounted OE chip. As an example, FIG. 2D shows the nonlinear design of support post size and spacing in detail.

A low stress mounting device in accordance with another alternative embodiment is shown in FIG. 3, which comprises the mounting plate 32, optical fiber 31, OE chip 34, and reinforcing plate 37. Mounting plate 32 preferably has a bulk body portion provided with an array of holes and V-groove design, and may be comprised of silicon, glass, ceramic, polymer, or metal material to provide for low thermal resistance and good heat transfer characteristics. The chip 34, via mounting plate 32, is mounted on the upper surface of reinforcing plate 37, which is conventionally accomplished by means of solder or adhesive. The reinforcing plate 37 may be comprised of the same material as the OE chip or may be comprised of other materials, such as silicon, glass, ceramic, polymer, or metal materials to provide rigidity.

FIG. 3A shows the cross sectional view of the mounting device of FIG. 3 along the line 4′-4′ which consists of mounting plate 32 and V-grooves 33 for receiving and supporting optical fibers 31, and array of hole support structures 35 for receiving and supporting OE chip. The V-grooves 33 allows for positioning of optical fibers 31. The positioning of OE chip 34 can be realized by positioning marks or stubs on the main body of mounting plate 32, which are not shown in the drawings.

The optical fibers may be single mode fibers 31, preferably with a core diameter on the order of 5-11 microns and a cladding diameter of approximately 120-130 microns. The OE chip 34 thickness (t) is preferably between 500-1000 microns. One or both ends of the optical waveguides of the OE chip exposed by dicing are preferably polished at an angle between 6 and 12 degrees relative to a direction normal to the mounting surfaces of the mounting plate, to minimize reflection of optical signals at the ends of the optical waveguides. In the end or ends of the OE chip 34, the V-groove 33 and the optical waveguide ends are preferably exposed and have laterally spaced relationship preferably at intervals of 250 microns. The array of hole support structures 35 may be in different geometric configuration, such as cylindrical holes, hexagonal holes, rectangular holes, triangular holes, and so on; and the dimension may vary from 50 microns to 3000 microns depended on the OE chip size and the disparity between their thermal expansion properties. Again,. It should be noted that the above-discussions regarding various dimensions are for illustrative purposes only and are not requirements for practicing the embodiments of the present invention.

FIGS. 3B-3D are diagrams of mounting plates used for low stress packaging in accordance with other alternative embodiments of the present invention. The mounting plate can include different kinds of array-of-holes support structures that are made of different materials, such as silicon, polymer, or metal materials, and the configuration of the holes can be selected in accordance with manufacturing considerations.

In FIG. 3B, cylindrical holes 35 are arranged in an array as support structures. The cylindrical holes may be made, for instance, by molding, laser drilling, or punching method. Hexagonal holes 45 are arranged in a honeycomb-like array as shown in FIG. 3C, which can also be fabricated by methods such as molding, punching, or reactive ion etching method. In FIG. 3D, the mounting plate 32 includes V-grooves and an array of rectangular holes 55 that are arranged into a pattern such that the walls dividing the holes do not form a straight line in any one direction that is longer than the lengths of two of the holes. Minimizing straight line extension in any one direction minimizes the amount of stress that may be accumulated in any one direction.

While the foregoing description relates to the OE chip, it should be understood that the aforementioned OE chip could be any other kind of optical device, for example, optoelectronic integrated circuits (OEIC), photonic integrated circuits (PIC) and a combination of optical and electronic chips.

Although the invention has been described in conjunction with limited number of different embodiments, it will be apparent to those skilled in the art that other alternatives, variations and modifications will be apparent in light of the foregoing description as being within the spirit and scope of the invention. Thus, the invention described herein is intended to embrace all such alternatives, variations and modifications that are within the spirit and scope of the following claims.

What I claim:

1. A. device for mounting an integrated circuit chip, said device comprising a mounting plate, said mounting plate having a plurality of closely spaced support posts extending therefrom for supporting said integrated circuit chip, wherein said plurality of closely spaced support posts span across the mounting surface of said mounting plate.

2. The device of claim 1, wherein each of said plurality of support posts includes a support surface on one end, and wherein said integrated circuit chip is mounted on the support surfaces of said plurality of support posts.

3. The device of claim 1, wherein said support posts are made of the same material as the mounting plate.

4. The device of claim 1, wherein said mounting plate includes a plurality of grooves for mounting and aligning fiber optic cables.

5. The device of claim 1, wherein said integrated circuit chip includes an optoelectronic integrated circuit.

6. The device of claim 1, wherein said plurality of supporting posts are rigid.

7. The device of claim 1, wherein said plurality of supporting posts have stress absorbing capacity such that the supporting posts can absorb stress caused by the different thermal expansion characteristics between the mounting plate and the mounted integrated circuit chip.

8. The device of claim 1, wherein the diameters of said plurality of supporting posts are different such that the widths of the supporting posts extending from the center area of the mounting plate are greater than the widths of the supporting posts extending from the peripheral of the mounting plate.

9. The device of claim 1, wherein the mounting surface of the integrated circuit chip and said plurality of support posts are made of different material.

10. The device of claim 1, wherein said plurality of support posts are made of silicon.

11. A device for mounting an integrated circuit chip, said device comprising a mounting plate having an array of holes, said array of holes having a plurality of closely spaced holes, said array of holes extending across the mounting surface of said mounting plate.

12. The device of claim 11, wherein said mounting place includes a plurality of grooves for mounting and aligning fiber optic cables.

13. The device of claim 11, wherein the diameters of said plurality of holes are equal.

14. The device of claim 11, wherein the plurality of holes are circular in shape.

15. The device of claim 11, wherein the plurality of holes are hexagonal in shape.

16. The device of claim 11, wherein the plurality of holes are rectangular in shape.

17. The device of claim 11, wherein said mounting plate is made of silicon, and wherein the walls of said array of holes are also made of silicon.

18. The device of claim 11, wherein the array of holes can expand or contract to absorb stress caused by the different thermal expansion properties of the mounting plate and the mounted integrated circuit.

19. A device for mounting an optoelectronic circuit chip, said device includes a mounting plate having a plurality of closely-spaced support structures extending across the mounting surface of said mounting plate,
wherein the mounting plate and the optoelectronic circuit chip are made of different material having different thermal expansion properties,
wherein said mounting plate includes a plurality of grooves for mounting and aligning fiber optic cables to the inputs of the mounted optoelectronic circuit chip,
wherein each of said plurality of support structures include a support surface for mounting said optoelectronic circuit chip, and
wherein said plurality of support structures can expand or contract to absorb stress caused by the thermal expansion differences between the mounting plate and the optoelectronic chip.

20. The device of claim 19, wherein said support structures are support posts.
